(19) United States
(12) Patent Application Publication
(10) Pub. No.: US 2005/0223209 A1
(43) Pub. Date: Oct. 6, 2005

(54) Apparatus for fast booting computer and method for the same

(75) Inventor: Yen Sheng Chang, Tai Chung Hsien (TW)

Correspondence Address: TROXELL LAW OFFICE PLLC;SUITE 1404, 5205 LEESBURG PIKE, FALLS CHURCH, VA, 22041, US

(73) Assignee: GIGA-BYTE TECHNOLOGY CO., LTD.

(21) Appl. No.: 10/813,023

(22) Filed: Mar. 31, 2004

(51) Int. Cl. G06F 9/00

(52) U.S. Cl. 713/2

(57) ABSTRACT

An apparatus for fast booting computer and method for the same are described. The apparatus has a memory accessing unit for storing a booting information, a main memory, and at least one CPU and a BIOS unit for setting the memory accessing unit as booting device of the computer. The CPU reads the booting information and saves the booting information to the main memory when the computer is booting.

### FIELD OF THE INVENTION

The present invention relates to an apparatus for fast booting a computer and a method for the same, and especially to an apparatus exploiting the fast accessing advantage of memory to fast boot a computer and a method for the same.

### BACKGROUND OF THE INVENTION

The present computer system, such as desktop computer, notebook computer or server computer, is generally equipped with data accessing units such as a floppy disk drive (FD), optical disk drive (OD), or hard disk drive (HD) to access data stored in a data-storing medium such as a floppy disk, optical disk drive, or hard disk. Moreover, at least one bootable operating system is stored in one of the above-mentioned data-storing media for booting a computer. A computer user can select his preferred booting device from those data accessing units by setting the BIOS of the computer.

A hard disk drive has the fastest data accessing speed in above-mentioned data accessing units. Generally, the default booting device is the hard disk drive in which an operating system such as MS Windows, IBM OS2 or LINUX is stored.

Certain factors must be considered during the booting process started with the hard disk drive. For examples, the data accessing time and the data searching time may delay the booting time of the computer.

The above-mentioned problem is worse when lots of data and programs are stored in the computer after long use. The files required for booting a computer such as booting file, registry file, execution file and association files may be scattered in the hard disk. The booting speed of the computer is extended when lots of scattered files need to be searched for and accessed. Moreover, the hard disk drive is legacy device not benefiting too much from the speed enhancement of motherboard, processor and memory.

The latest operating system is developed to provide more functionality for the user. An operating system with a sleep mode can save the current program-executing status and current monitor screen in a memory before cutting off electrical power supplied to monitor, hard disk drive, motherboard and processor. When the computer exits the sleep mode, the program-executing status and monitor screen saved in the memory are fetched and electrical power is supplied again to monitor, hard disk drive, motherboard and processor. The computer with this kind of operating system can be restored to its original status before entering the sleep mode with a fast restoring speed. However, electrical power is needed to power the memory during sleep mode operation.

Moreover, a restoring software can save the current program-executing status and current monitor screen as an image file in hard disk before powering off the computer. After the computer is again turned on, the computer will be restored to original program-executing status and monitor screen with reference to the image file in hard disk. The restoring software has the advantage of no power requirement in power off state of computer. However, the computer still needs data accessing and data searching time for the image file in the hard disk, which causes slower booting time.

### SUMMARY OF THE INVENTION

It is an object of the present invention to provide an apparatus exploiting the fast accessing advantage of memory to fast boot a computer and a method for the same.

To achieve the above object, the present invention provides an apparatus for fast booting computer and method for the same. The apparatus comprises a memory accessing unit for storing booting information, a main memory, at least one CPU and a BIOS unit for setting the memory accessing unit as the booting device of the computer. The CPU reads the booting information and saves the booting information in the main memory when the computer is booting.

In one aspect of the present invention, the booting information is preferably at least one booting file, registry file, execution file and association file for an operating system, or a booting image file.

In another aspect of the present invention, the booting information is booting-related information in main memory before shutting down the computer.

In still another aspect of the present invention, the memory accessing unit is non-volatile memory or volatile memory. When the memory accessing unit is volatile memory, electrical power is needed to power the memory accessing unit after the computer is shut down.

The various objects and advantages of the present invention will be more readily understood from the following detailed description when read in conjunction with the appended drawing

### BRIEF DESCRIPTION OF DRAWINGS

The foregoing aspects and many of the attendant advantages of this invention will be more readily appreciated as the same becomes better understood by reference to the following detailed description, when taken in conjunction with the accompanying drawings, wherein:

FIG. 1 shows the block diagram of a computer system the apparatus according to the present invention; and

FIGS. 2A, 2B and 2C show the flowchart of the present invention.

### DETAILED DESCRIPTION OF THE INVENTION

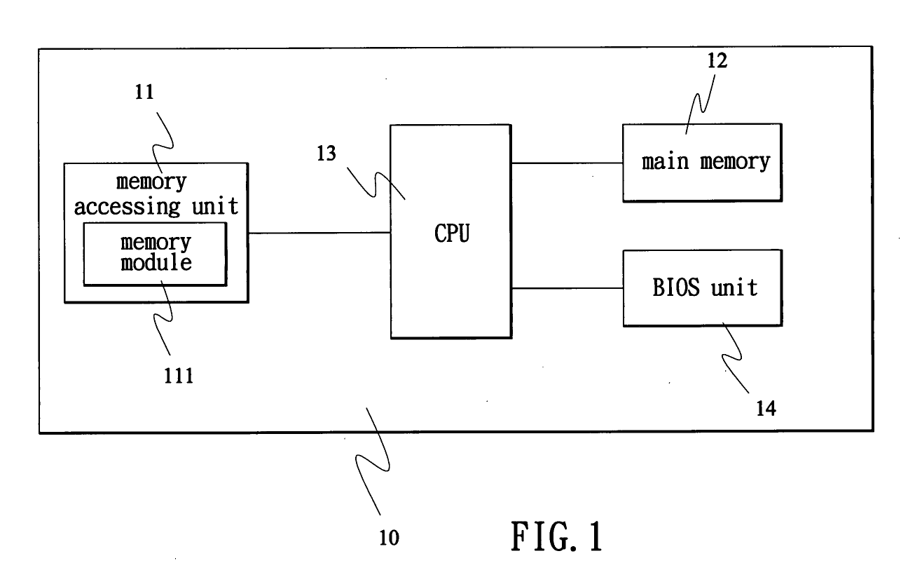

FIG. 1 shows the block diagram of a computer system 10 with the apparatus for fast booting computer according to the present invention. The apparatus for fast booting computer according to the present invention exploits the fast data accessing ability of memory to overcome the delay problem in prior art. The computer system can be desktop computer, notebook computer or server computer.

The computer system 10 mainly comprises a memory accessing unit 11, a main memory 12, at least one CPU (central processing unit) 13 and a BIOS unit 14. The memory accessing unit 11 has at least one memory module 111, preferably a non-volatile memory such as a flash memory to store booting information or a volatile memory. When the memory module 111 is volatile memory such as DRAM, electrical power is supplied to the memory module 111 when the computer is turned off.

Today, several computer models are designed to provide electrical power to certain interfaces or peripheral devices when the computer is shut down and still plugged into a power socket. The present invention exploits this feature to sustain the memory module 111 with power from interfaces or peripheral devices.

The memory accessing unit 11 can be designed as interface card for inserting into PCI bus, or a built-in module mounted on a motherboard. The memory accessing unit 11 can be electrically connected to the main memory 12 through IDE interface, SCSI interface, or RAID interface.

The booting information stored in the memory accessing unit 11 comprises a plurality of booting files, registry files, execution files and association files essential for booting the computer. Alternatively, the booting information can be a booting image file constructed by address allocation of the executing program, data and association data in the main memory 12 when the computer is booting. Therefore, the computer can skip unnecessary booting processes by directly mapping the booting information stored in the image file into the main memory 12.

The main memory 12 is connected to the memory accessing unit 11 and stores the program and data required by the CPU 13. More particularly, the main memory 12 stores the booting information when the computer is booting. The main memory 12 is preferably DRAM, DDRAM or RAMBUS.

The CPU 13 is connected to the memory accessing unit 11 and the main memory 12. The CPU 13 reads the booting information when the computer is booting and then stores the booting information in the main memory 12 for further execution.

The computer generally performs booting process by a booting device designated by the BIOS unit 14 and the booting device is nowadays limited to floppy disk drive (FD), optical disk drive (OD), hard disk drive (HD), network interface card (NIC), etc. The memory accessing unit 11 according to the present invention has an IDE interface, SCSI interface, or RAID interface, which is compatible with the booting device setting of current BIOS. It should be noted the memory accessing unit 11 according to the present invention can have other types of interface to meet future computer's standard and save IDE and SCSI resources.

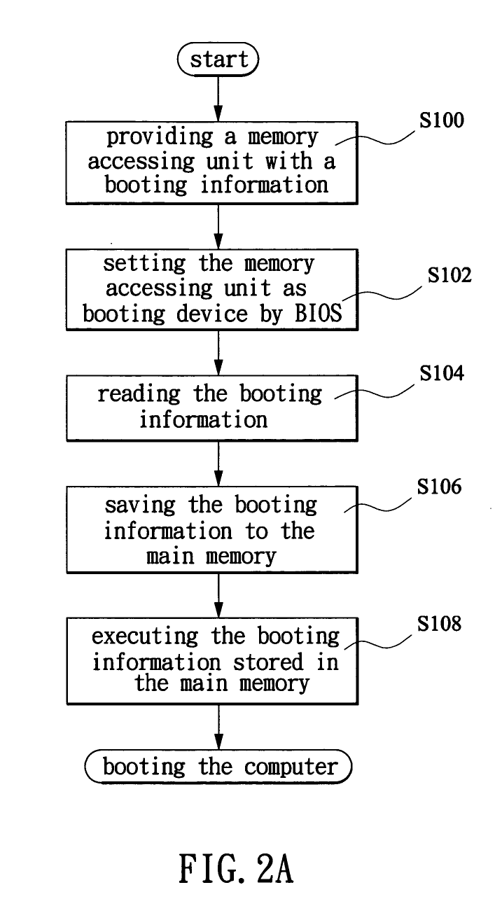

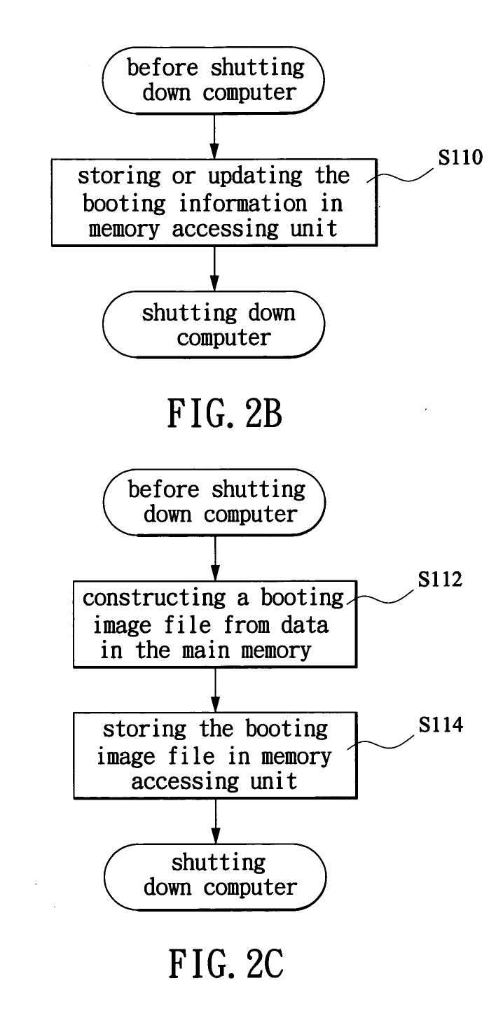

FIGS. 2A, 2B and 2C show the flowchart of the present invention. In step S100, a memory accessing unit 11 is provided and incorporated with a memory module 111 for storing a booting information for a computer. Afterward, in step S102, the memory accessing unit 11 is set as a booting device of the computer by setting a BIOS unit 14. In step S104, the computer is booting and a CPU 13 of the computer reads the booting information stored in the memory module 111. In a later step S106, the booting information is stored in a main memory 12. In a later step S108, the CPU 13 executes the booting information stored in the main memory 12 to complete quickly the booting process for the computer.

In the present invention, the booting information can be unvarying booting files for computer. It should be noted some files such as execution files or association files in the booting information might be changed with updating of the computer. For example, new software or hardware might be installed in the computer, or changed by a user setting such as desktop background.

As shown in FIG. 2B, before shutting down the computer, a step S110 is executed. In step S110, the booting information including booting file, registry file, execution file and association files is updated or stored in the memory accessing unit 11. Therefore, the computer can be booted with new settings for subsequent use.

Alternatively, as shown in FIG. 2C, steps S112 and S114 are executed before shutting down the computer. In step S112, a booting image file is created, incorporating information stored in the main memory 12. The information can be, but is not limited to, program, data and information associated with the operating system. In step S114, the booting image file is stored in the memory accessing unit 11. Therefore, the computer can be booted with the information stored in the booting image file.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

1. A method for fast booting a computer, the computer having a main memory, the method comprising the steps of:
providing a memory accessing unit having a memory module for storing booting information for the computer;
reading the booting information and saving the booting information in the main memory when the computer is booting; and
executing the booting information stored in the main memory.

2. The method for fast booting a computer as in claim 1, wherein the computer is a desktop computer, notebook computer or server computer.

3. The method for fast booting a computer as in claim 1, wherein the main memory is at least a DRAM, DDRAM or RAMBUS.

4. The method for fast booting a computer as in claim 1, wherein the memory module is a non-volatile memory.

5. The method for fast booting a computer as in claim 4, wherein the non-volatile memory is a flash memory.

6. The method for fast booting a computer as in claim 1, wherein the memory module is a volatile memory and electrical power is supplied to the memory module when the computer is shut down.

7. The method for fast booting a computer as in claim 1, wherein the booting information comprises at least a booting file, registry file, execution file or association file for an operating system.

8. The method for fast booting a computer as in claim 1, wherein the booting information is an operating system.

9. The method for fast booting a computer as in claim 7, wherein the operating system is MS Windows, IBM OS2 or LINUX.

10. The method for fast booting a computer as in claim 8, wherein the operating system is MS Windows, IBM OS2 or LINUX.

11. The method for fast booting a computer as in claim 1, wherein the booting information is a booting image file.

12. The method for fast booting a computer as in claim 11, wherein the booting image file is constructed by booting information stored in the main memory when the computer is turned on.

13. The method for fast booting a computer as in claim 1, further comprising a step, after the step of providing the memory accessing unit, of setting the memory accessing unit as a booting device of the computer through BIOS setting of the computer.

14. The method for fast booting a computer as in claim 1, wherein the memory accessing unit is connected to the main memory through an IDE interface, SCSI interface, RAID interface or PCI interface.

15. The method for fast booting a computer as in claim 1, wherein at least one CPU reads and executes the booting information when the computer is booting.

16. The method for fast booting a computer as in claim 1, further comprising a step, after the step of executing the booting information, of: constructing a booting image file composed of booting information in the main memory; and
saving the booting image file in the memory accessing unit before shutting down the computer.

17. The method for fast booting a computer as in claim 1, further comprising a step, after the step of executing the booting information, of:
saving at least one booting file, registry file, execution file and association file for an operating system in the memory accessing unit before shutting down the computer.

18. An apparatus for fast booting a computer, comprising:
a memory accessing unit having a memory module for storing a booting information for the computer;
a main memory connected to the memory accessing unit for storing the booting information; and
at least one CPU connected to the memory accessing unit and the main memory, the CPU reading the booting information and saving the booting information to the main memory when the computer is booting.

19. The apparatus for fast booting a computer as in claim 18, wherein the computer is a desktop computer, notebook computer or server computer.

20. The apparatus for fast booting a computer as in claim 18, further comprising a BIOS unit to set the memory accessing unit as a booting device of the computer.

21. The apparatus for fast booting a computer as in claim 18, wherein the memory accessing unit is connected to the main memory through a IDE interface, SCSI interface, RAID interface or PCI interface.

22. The apparatus for fast booting a computer as in claim 18, wherein the memory module is a non-volatile memory.

23. The apparatus for fast booting a computer as in claim 22, wherein the non-volatile memory is a flash memory.

24. The apparatus for fast booting a computer as in claim 18, wherein the memory module is a volatile memory and an electrical power is supplied to the memory module when the computer is shut down.

25. The apparatus for fast booting a computer as in claim 18, wherein the booting information comprises at least one booting file, registry file, execution file and association file for an operating system.

26. The apparatus for fast booting a computer as in claim 18, wherein the booting information is an operating system.

27. The apparatus for fast booting a computer as in claim 25, wherein the operating system is MS Windows, IBM OS2 or LINUX.

28. The apparatus for fast booting a computer as in claim 26, wherein the operating system is MS Windows, IBM OS2 or LINUX.

29. The apparatus for fast booting a computer as in claim 18, wherein the booting information is a booting image file.

30. The apparatus for fast booting a computer as in claim 29, wherein the booting image file is constructed by booting information stored in the main memory when the computer is turned on.

31. The apparatus for fast booting a computer as in claim 18, wherein the main memory is at least a DRAM, DDRAM or RAMBUS.
